(19) United States
(12) Patent Application Publication
(10) Pub. No.: US 2025/0243389 A1
(43) Pub. Date: Jul. 31, 2025

(54) COMPOSITION COMPRISING ADDITIVE HAVING A POLYCYCLIC AROMATIC GROUP

(71) Applicant: E INK CORPORATION, Billerica, MA (US)

(72) Inventors: Lynne A. MCCULLOUGH, Brooklyn, NY (US); Eugene BZOWEJ, Dunstable, MA (US); David Darrell MILLER, Wakefield, MA (US); Craig A. HERB, Medford, MA (US)

(21) Appl. No.: 19/069,651

(22) Filed: Mar. 4, 2025

Related U.S. Application Data
(63) Continuation of application No. 17/474,162, filed on Sep. 14, 2021.
(60) Provisional application No. 63/078,476, filed on Sep. 15, 2020.

(51) Int. Cl. C09J 9/02; C08F 20/18; C08F 292/00; C08K 3/04; C09J 4/00; C09J 133/10; G02F 1/167; G02F 1/1675

(52) U.S. Cl. CPC C09J 9/02; C08F 20/18; C08F 292/00; C08K 3/041; C09J 4/00; C09J 133/10; G02F 1/167; C08K 2201/001; C08K 2201/011; G02F 2001/1678; G02F 2202/28

(57) ABSTRACT

A method of making a polymer film from a dispersion composition comprising an electrically conductive filler, a polymerizable monomer or oligomer, and an additive comprising a polycyclic aromatic group.

### RELATED APPLICATIONS

This application is a divisional application and claims the benefit of copending application Ser. No. 17/474,162 filed on Sep. 14, 2021 (Publication No. 2022/0081596 A1), which claims priority to U.S. Provisional Patent Application No. 63/078,476 filed on Sep. 15, 2020, which is incorporated by reference in its entirety, along with all other patents and patent applications disclosed herein.

### BACKGROUND OF THE INVENTION

The present invention relates to a dispersion composition comprising a filler, a polymerizable monomer or oligomer, and an additive having a polycyclic aromatic group. It also relates to a polymer film or polymer part that can be prepared using the dispersion composition, and a method of making a polymer film or polymer part. The polymer film can be used as an electrode, a conductive layer, an adhesive layer, a binder for encapsulated electro-optic medium layer, a sealing layer, an edge seal, and a barrier film of a device or an article. The polymer film may have anisotropic conductivity. The polymer part can be used for any product that comprises a polymer part, for example, a product that comprises a colored plastic solid part.

The term “electro-optic”, as applied to a material or a device or a display or an assembly, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range. The terms “electro-optic device” and “electro-optic display” are herein considered synonymous. The term “electro-optic assembly” as used herein may be an electro-optic device. It may also be a multi-layered component that is used for the construction of the electro-optic device. Thus, for example, a front plane laminate, which will be described below, is also considered an electro-optic assembly.

The term “gray state” is used herein in its conventional meaning in the imaging art to refer to a state intermediate two extreme display states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in display state may not be a color change at all. The terms “black” and “white” may be used hereinafter to refer to the two extreme display states of a display, and should be understood as normally including extreme display states which are not strictly black and white, for example the aforementioned white and dark blue states. The term “monochrome” may be used hereinafter to denote a drive scheme that only drives pixels to their two extreme display states with no intervening gray states.

Some electro-optic materials are solid in the sense that the materials have solid external surfaces, although the materials may, and often do, have internal liquid-or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Several types of electro-optic displays are known. One type of electro-optic display is a rotating bichromal member type as described, for example, in U.S. Pat. Nos. 5,808,783; 5,777,782; 5,760,761; 6,054,071 6,055,091; 6,097,531; 6,128,124; 6,137,467; and 6,147,791. Although this type of display is often referred to as a “rotating bichromal ball” display, the term “rotating bichromal member” is preferred as more accurate since in some of the patents mentioned above the rotating members are not spherical. Such a display uses a large number of small bodies (typically spherical or cylindrical) which have two or more sections with differing optical characteristics, and an internal dipole. These bodies are suspended within liquid-filled vacuoles within a matrix, the vacuoles being filled with liquid so that the bodies are free to rotate. The appearance of the display is changed by applying an electric field thereto, thus rotating the bodies to various positions and varying which of the sections of the bodies is seen through a viewing surface. This type of electro-optic medium is typically bistable.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038, 6,870,657, and 6,950,220. This type of medium is also typically bistable.

Another type of electro-optic display is an electro-wetting display developed by Philips and described in Hayes, R.A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications, assigned to or in the names of the Massachusetts Institute of Technology (MIT), E Ink Corporation, E Ink California, LLC and related companies, describe various technologies used in encapsulated and microcell electrophoretic and other electro-optic media. Encapsulated electrophoretic media comprise numerous small capsules, each of which itself comprises an internal phase containing electrophoretically mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. Hereinafter, the term “microcavity electrophoretic display” may be used to cover both encapsulated and microcell electrophoretic displays. The technologies described in these patents and applications include:
(a) Electrophoretic particles, fluids and fluid additives; see for example U.S. Pat. Nos. 7,002,728 and 7,679,814.
(b) Capsules, binders and encapsulation processes; see for example U.S. Pat. Nos. 6,922,276, 7,184,197, and 7,411,719.
(c) Microcell structures, wall materials, and methods of forming microcells; see for example U.S. Pat. Nos. 7,072,095 and 9,279,906.
(d) Methods for filling and sealing microcells; see for example U.S. Pat. Nos. 7,144,942 and 7,715,088.
(e) Films and sub-assemblies containing electro-optic materials; see for example U.S. Pat. Nos. 6,982,178 and 7,839,564.
(f) Backplanes, adhesive layers and other auxiliary layers and methods used in displays; see for example U.S. Pat. Nos. 7,116,318 7,535,624. 7,012,735 and 7,173,752.
(g) Color formation and color adjustment; see for example U.S. Pat. Nos. 7,075,502 and 7,839,564.
(h) Methods for driving displays; see for example U.S. Pat. Nos. 7,012,600 and 7,453,445.
(i) Applications of displays; see for example U.S. Pat. Nos. 7,312,784 and 8,009,348.
(j) Non-electrophoretic displays, as described in U.S. Pat. No. 6,241,921 and U.S. Patent Application Publication No. 2015/0277160; and applications of encapsulation and microcell technology other than displays; see for example and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display. In such a display, the electrophoretic medium comprises a plurality of discrete droplets of an electrophoretic fluid and a continuous phase of a polymeric material. The discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552, 6,130,774, 6,144,361, 6,172,798, 6,271,823, 6,225,971, and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques. Thus, the resulting display can be flexible. Further, because the display medium can be printed using a variety of methods it can be made inexpensively.

Other types of electro-optic materials may also be used in the present invention. Of particular interest, bistable ferroelectric liquid crystal displays (FLC's) are known in the art.

An electrophoretic display typically comprises, in addition to the electro-optic material layer, at least two other layers disposed on opposed sides of the electro-optic material layer. One of these layers is an electrode layer. In most electro-optic devices both these layers are electrode layers, and at least one the electrode layers are patterned to define the pixels of the device. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a light-transmissive, single continuous electrode and the other electrode layer is patterned into a matrix of pixel electrodes, each of which defines one pixel of the display. That is, one of the layers is typically an electrically-conductive light-transmissive layer and the other layer, typically called backplane substrate, comprises a plurality of pixel electrodes configured to apply an electrical potential between the electrically-conductive light-transmissive layer and the pixel electrodes. In another type of electro-optic device, which is intended for use with a stylus, print head or similar movable electrode separate from the display, only one of the layers adjacent the electro-optic layer comprises an electrode, the layer on the opposed side of the electro-optic layer typically being a protective layer intended to prevent the movable electrode damaging the electro-optic material layer.

The manufacture of a three-layer electro-optic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. A very similar process can be used to prepare an electrophoretic display usable with a stylus or similar movable electrode by replacing the backplane with a simple protective layer, such as a plastic film, over which the stylus or other movable electrode can slide. In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive. Similar manufacturing techniques can be used with other types of electro-optic displays. For example, a microcell electrophoretic medium or a rotating bichromal member medium may be laminated to a backplane in substantially the same manner as an encapsulated electrophoretic medium.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light-transmissive electrically-conductive layer; a layer of a solid electro-optic medium; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trade Mark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well adapted to mass production since the front plane laminate may be mass-produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations; typically, in a first lamination, the double release sheet is laminated to a front electrode to form a front sub-assembly, and then, in a second lamination, the front sub-assembly is laminated to a backplane to form the final display, although the order of these two laminations could be reversed, if desired.

As an alternative construction, U.S. Pat. No. 7,839,564 describes a so-called “inverted front plane laminate”, which is a variant of the front plane laminate described in U.S. Pat. No. 6,982,178. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane.

Lamination adhesive layers of electro-optic desplays that are located between an electro-optic material layer and an electrode layer may significantly affect the preformance of the corresponding electro-optic display. Specifically, if the conductivity of the adhesive layer at the direction perpendicular to the plane of the adhesive layer (z-direction) is low, a substantial voltage drop across the lamination adhesive layer will occur within the lamination adhesive layer. This will require an increase in the applied voltage across the electrode layers to form the desired image, which will increase the power consumption to operate the display. On the other hand, if the conductivity of the adhesive layer is high at the direction of the plane of the adhesive layer (also called lateral conductivity, or conductivity at the x and y directions), a cross talk between adjacent pixel electrodes occurs, reducing the resolution of the display and leading to poor image quality. The phenomenon is called blooming. Thus, blooming refers to the tendency for application of a voltage to a pixel electrode to cause a change in the optical state of the electro-optic medium over an area larger than the physical size of the pixel electrode. Because the conductivity of most materials rapidly decreases with increasing temperature, the blooming phenomenon becomes more pronounced at higher temperatures. Conversely, at low temperatures, the resulting reduced conductivity may reduce the speed of switching between images or increase the voltage drop and the energy consumption.

Where conductive fillers are used to control the conductivity of adhesive layers or other polymer films, they are typically predispersed in a liquid carrier to break large aggregates, increasing the effectiveness and efficiency of the conductive fillers. Typically, surfactants are included in the liquid carrier to promote the de-aggregation process. However, the presence of surfactant molecules in the adhesive layer may significantly increase the lateral conductivity of the adhesive layer (conductivity at the x and y directions), because of the high mobility of the surfactant molecules in the adhesive layer, which increases blooming.

The present invention avoids this problem. Specifically, the additive used in the dispersion composition of the present invention, replaces (or reduces the amount of) the surfactant as a way to promote the de-aggregation of the conductive fillers. At the stage of the cured adhesive layer, the additive is immobilized in the polymer matrix of the adhesive layer by becoming part of the polymer matrix of the layer. Furthermore, the cured adhesive layer may be formed in a manner so that the cured adhesive layer exhibits anisotropic conductivity; that is, the cured adhesive layer has higher conductivity at the z direction (perpendicular to the plane of the adhesive layer) compared to the conductivity at the x and y directions, which are orthogonal to the z direction. As mentioned above, high conductivity in the x and y directions causes cross talk, which results in blooming. Thus, adhesive layers having anisotropic conductivity as described above mitigate blooming and at the same time enable economical operation of the device. Thus, the technology of the present invention can contribute to low power consumption with low blooming.

The present invention is also useful for polymer films and polymer parts that exhibit good barrier and mechanical properties. It is well known that fillers having high specific surface area improve the barrier and mechanical properties of polymers films and polymer parts. It is also well known that filler particles must be de-aggregated in order to achieve the state of high specific surface area (small particles). Surfactants are essential for the de-aggregation process. However, the presence of surfactant molecules may also be detrimental to the barrier and mechanical properties in the polymer films and polymer parts. The current invention improves barrier and mechanical properties of polymer films and polymer parts by enabling the absence of surfactant molecules in a cured polymer film or a cured polymer part by incorporating the material used for the de-aggregation of the filler particles into the polymer matrix.

### SUMMARY OF THE INVENTION

Aspects of the present invention relate to (a) a dispersion composition comprising a filler comprising particles, a polymerizable monomer or oligomer, and an additive comprising a polycyclic aromatic group, (b) a polymer film formed by the dispersion composition, (c) an electro-optic device comprising the polymer film, and (d) a method of making a polymer film using the dispersion composition.

In one aspect, the present invention provides a dispersion composition comprising: a filler comprising particles, a polymerizable monomer or oligomer; and an additive that is represented by Formula I.

R1—(CH₂)ₙ—Y—Z Formula I

R1 of Formula I is a polycyclic aromatic group comprising from 10 to 24 aromatic atoms, the aromatic atoms being selected from the group consisting of carbon, nitrogen, oxygen, and sulfur; n is 0, 1, 2, 3, 4, 5, 6, 7, or 8. Y of Formula I is a functional group selected from the group consisting of ester, thioester, amide, urea, thiourea, carbamate, S-thiocarbamate, beta hydroxyester, -Q-CR2R3—CR4(OH)—, and -Q-SiR5R6—, Q being O, NH or S; R2, R3, R4 being independently hydrogen, or linear or branched alkyl group having 1-6 carbon atoms; R5, R6 being independently alkyl groups having 1-4 carbon atoms; Z of Formula I is a group comprising a reactive functional group, the reactive functional group being selected from the group consisting of acrylate, methacrylate, styrene, methyl styrene, epoxy, isocyanate, hydroxy, thiol, carboxylic acid, carboxylic acid halide, silane, and amine. The reactive functional group is able to participate in a polymerization reaction of the polymerizable monomer or oligomer. Functional group Y may be —O—C(O)— or —O—C(O)—NH—, and Z may comprise acrylate, methacrylate, styrene, or methylstyrene.

The filler may be conductive. The filler may be selected from the group consisting of carbon nanotubes, carbon nanofibers, graphene, carbon black, and mixtures thereof. The dispersion may further comprise a liquid carrier selected from the group consisting of an aqueous carrier, a non-aqueous carrier, and a combination thereof. All aromatic atoms may be carbon atoms. The polymerizable monomer or oligomer may be a material selected from the group consisting of an acrylate, methacrylate, polyacrylate, polymethacrylate, vinyl acrylate, vinyl methacrylate, styrene, methylstyrene, epoxide, isocyanate, carboxylic acid, carboxylic acid halide, silane, alcohol, thiol, amine, and mixtures thereof.

In another aspect, the present invention provides a polymer film formed by curing of the aforementioned dispersion composition. The polymer film may be a conductive film, a barrier film, an electrode, a sealing layer, a binder for encapsulated electro-optic medium layer, an edge seal or an adhesive layer. In another aspect, the present invention provides a polymer part formed by curing the aforementioned dispersion composition.

In another aspect, the present invention provides an electro-optic device comprising: a first electrode layer, an electro-optic material layer, a first adhesive layer, and a second electrode layer comprising a plurality of pixel electrodes. The electro-optic material layer is disposed between the first and second electrode layer. The first adhesive layer is formed by the dispersion composition comprising a filler comprising conductive particles, a polymerizable monomer or oligomer; and an additive that is represented by Formula I. R1 of Formula I is a polycyclic aromatic group comprising from 10 to 24 aromatic atoms, the aromatic atoms being selected from the group consisting of carbon, nitrogen, oxygen, and sulfur; n is 0, 1, 2, 3, 4, 5, 6, 7 or 8. Y of Formula I is a functional group selected from the group consisting of ester, thioester, amide, urea, thiourea, carbamate, S-thiocarbamate, beta hydroxyester, -Q-CR2R3—CR4(OH)—, and -Q-SiR5R6—, Q being O, NH or S; R2, R3, R4 being independently hydrogen, or linear or branched alkyl group having 1-6 carbon atoms; R5, R6 being independently alkyl groups having 1-4 carbon atoms. Z of Formula I is a group comprising a reactive functional group, the reactive functional group being selected from the group consisting of acrylate, methacrylate, styrene, methyl styrene, epoxy, isocyanate, hydroxy, thiol, carboxylic acid, carboxylic acid halide, silane, and amine. The reactive functional group is able to participate in a polymerization reaction of the polymerizable monomer or oligomer. The particles of the electrically conductive filler may be aligned in the adhesive layer at a z direction perpendicular to a plane of the first adhesive layer. A a result, the adhesive layer may exhibit anisotropic conductivity. The conductivity at the z direction may be higher than the conductivity at the other two directions x and y, which are orthogonal to the z direction.

In another aspect, the present invention provides a method of making a polymer film comprising the steps: (1) mixing a dispersion composition comprising (a) a filler selected from the group consisting of carbon nanotubes, carbon nanofibers, graphene, and carbon black; (b) a polymerizable monomer or oligomer; and (c) an additive that is represented by Formula I, wherein R1 is a polycyclic aromatic group comprising from 10 to 24 aromatic atoms, the aromatic atoms being selected from the group consisting of carbon, nitrogen, oxygen, and sulfur; n is 0, 1, 2, 3, 4, 5, 6, 7 or 8; Y is a functional group selected from the group consisting of ester, thioester, amide, urea, thiourea, carbamate, S-thiocarbamate, beta hydroxyester, -Q-CR2R3—CR4(OH)—, and -Q-SiR5R6—; Q being O, NH or S; R2, R3, R4 being independently hydrogen, or linear or branched alkyl group having 1-6 carbon atoms; R5, R6 being independently alkyl groups having 1-4 carbon atoms; and Z is a group comprising a reactive functional group, the reactive functional group being selected from the group consisting of acrylate, methacrylate, styrene, methyl styrene, epoxy, isocyanate, hydroxy, thiol, carboxylic acid, carboxylic acid halide, silane, and amine; (2) applying the composition onto a substrate as a wet film; and (3) curing the applied composition to polymerize the polymerizable monomer or oligomer along with the additive. The curing may be performed thermally or via exposure to ultraviolet light. Before the curing step, an electric field may be applied across the applied wet film to align the filler particles in the wet film at a z direction perpendicular to a plane of the applied wet film. The dispersion composition may further comprise a liquid carrier.

Other aspects and various non-limiting embodiments of the present invention are described in the following detailed description. In cases where the present specification and document incorporated by reference include conflicting and/or inconsistent disclosure, the present specification shall control. If two or more documents incorporated by reference include conflicting and/or inconsistent disclosure with respect to each other, then the document having the later effective date shall control,

### BRIEF DESCRIPTION OF DRAWINGS

Various aspects and embodiments of the application will be described with reference to the following figures. It should be appreciated that the figures are not necessarily drawn to scale.

FIG. 1 illustrates the conductivity at z direction and at the x and y directions of an adhesive layer (or a polymer film).

FIG. 2A is a schematic illustration of an electro-optic device comprising an adhesive layer.

FIG. 2B is a schematic illustration of an electro-optic device comprising two adhesive layers.

FIG. 3 is a schematic illustration of an electro-optic device comprising one adhesive layer and an electro-optic layer having electrophoretic medium.

FIGS. 4 and 5 are schematic illustrations of electro-optic device each of which comprises two adhesive layers and an electro-optic layer having an electrophoretic medium.

FIG. 6 is a schematic illustration of an electro-optic assembly that is a front plane laminate comprising an adhesive layer and a release sheet.

FIG. 7 is a schematic illustration of an electro-optic assembly that is a double release sheet comprising two adhesive layers and two release sheets.

FIGS. 8A, 8B, and 8C are schematic illustrations of the steps of an example of a method of making of a dispersion composition and the corresponding polymer film.

FIG. 9 represents the reaction for the preparation of 4-(1-pyrenyl)butyl acrylate, which is an example of an additive of the dispersion composition of the present invention.

FIG. 10 represents the reaction of 1-pyrenemethanol and 3-isopropenyl-α,α-dimethylbenzyl isocyanate. The product is an example of an additive of the dispersion composition of the present invention,

FIG. 11 shows photographs of an inventive dispersion (stable) versus a comparative dispersion (filler settled).

Other aspects, embodiments and features of the invention will become apparent from the following detailed description when considered in conjunction with the accompanying drawings.

### DETAILED DESCRIPTION OF THE INVENTION

“Dispersion” is a mixture comprising solid particles and a carrier. The carrier may be a liquid.

“Surfactant”, or “surface active agent”, is a material with a molecular structure having both a hydrophilic and a lipophilic (or a hydrophobic) functional groups.

The term “predispersion” in relation to solid particles in a carrier means the process of the preparation by milling, by high speed mixing, or by any other process. A predispersion is usually combined with additional components to prepare a more complex dispersion, typically having a lower content of solid particles, which is able to be actually used to make a coating, a film or a part. Various types of equipment may be used to prepare a predispersion including dissolvers, rotor-stators, ball mills, media mills, and extruders. Typically, predispersions comprise surfactant molecules that enable wetting of the solid particle surfaces by the carrier, which is required for an efficient de-aggregation of the particles and the long term stability of the dispersion. The term “predispersed” in relation to solid particles means that the particles have been exposed to a “predispersion” process. Sometimes the terms “predispersion” and “dispersion” processes are used interchangeably. For easy to disperse particles, the predispersion process may not be necessary. However, for particles (pigment, fillers, etc.) wherein the desired specific surface area is high (corresponding to small particle size), a predispersion process using an aggressive, high-energy process is necessary. Dispersion comprising solid particles with high specific surface area also require sufficient content of a surfactant or a combination of surfactants to wet and stabilize the solid particles.

A “filler” is a material comprising of solid particles that is added into a composition to improve specific properties. Certain fillers called “conductive fillers” increase the conductivity of a polymer films. Other fillers, especially those having high specific surface area, are used to improve the mechanical, thermal, and barrier properties of polymer films. “Polymer films” are films that comprise a polymer. Non-limiting examples of uses of polymer films include electrode layers, conductive layers, adhesive layers, sealing layers, binder layer of the electro-optic material layer, edge seals, and barrier films. An example of a barrier film is a packaging film that is used to package foods and other items that are sensitive, for example, to oxygen and moisture. A polymer film has thickness from 0.1 μm to 5 mm. Polymer parts are solid parts that can be used as a structural or functional components of an article or a device. A polymer part has thickness larger than 5 mm. Non-limiting examples of polymer parts include components of packages, furniture, engines, vehicles, boats, and other articles and devices. Polymer parts may be manufactured by injection molding, blow molding, 3D printing, and others. They may comprise thermoplastic or thermosetting polymers.

The terms “alkenyl” and “alkynyl” are given their ordinary meaning in the art and refer to unsaturated aliphatic groups analogous in length and possible substitution to the alkyls described above, but that contain at least one double or triple bond respectively.

“Specific surface area” of solid particles is the total surface area of the material per unit of mass. Specific surface are of solid particles can be measured by gas adsorption (e.g. nitrogen) on a powder material by the BET method. It is typically express in units of m²/g.

“Aspect ratio” of a particle is defined as the ratio of its major dimension and minor dimension.

The term “curing” refers to the transition of a composition that comprises a reactive monomer or oligomer from a liquid phase to a solid or semi-solid phase. The term “monomer” also includes macromonomers. A macromonomer is a macromolecule comprising at least one functional group that enables it to act as a polymerizable monomer. In the context of the present invention, curing may be achieved by exposing a dispersion composition to thermal or light energy. The dispersion composition may be applied onto a surface before its exposure to thermal or light energy. The application may be achieved by any coating or printing process. The dispersion composition may also be included into a mold before its exposure to thermal or light energy. Alternatively, the dispersion composition may be exposed to thermal or light energy as it is mixed in an extruder or a mixer. The monomer or oligomer is polymerized during the curing process. The light energy may be in the ultraviolet region of the electromagnetic radiation. The polymerization reaction that takes place during the curing process may include addition polymerization. It may also include condensation polymerization.

“Cross-linking” is a bond that links one polymer chain to another polymer chain. It is achieved by using “cross-linking agents”, which is a material that is able to react or interact with two or more polymer chains.

“Chain extension” is a process of reacting a molecule with an oligomer or polymer forming a reactive polymeric intermediate that can react with another oligomer or polymer to increase its molecular weight. The reactive molecule is called a “chain-extending reagent”.

“Volume resistivity” of a material is the inverse of “volume conductivity”. Volume conductivity of a material represents the material's ability to conduct electric current. It is measured in Siemens per meter (S/m) or Siemens per cm (S/cm). Volume resistivity is measured in Ohm·m or Ohm·cm. Volume resistivity of a solid material is measured by standard method ASTM D257.

The term “polycyclic aromatic group” as used herein refers to a substituent of the additive molecule. That is, the additive that is used in the inventive composition is a compound that comprises a polycyclic aromatic group. The term “polycyclic aromatic group” is wider than the term “polycyclic aromatic hydrocarbon” or “PAH”, which is known in the art. The “polycyclic aromatic group” of the additive in the context of the present invention may contain a polycyclic aromatic group having aromatic carbon atoms, also aromatic atoms other than carbon (heteroatoms), such as oxygen, sulfur, and nitrogen. The polycyclic aromatic group may comprise two or more condensed aromatic rings.

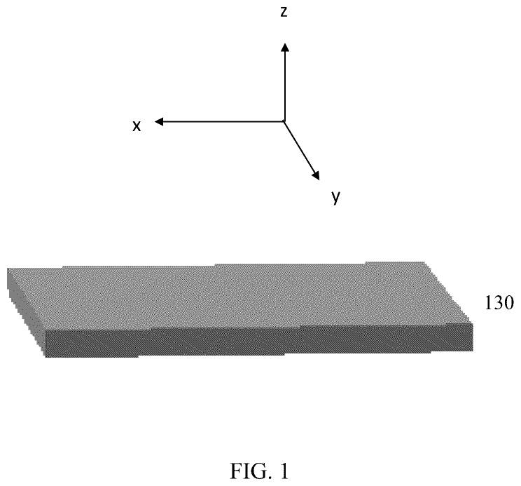

The term “conductivity” as used herein refers to electrical conductivity, unless otherwise stated. Conductivity of an adhesive layer or a polymer film at z direction is the conductivity at a direction perpendicular to a plane of the layer or the film. The term “plane” in reference to a layer or a film is a plane that is defined by the upper surface of the layer (or the film) or any plane that is parallel to the plane that is defined by the upper surface of the layer (or film). Conductivity of an adhesive layer or a polymer film at x and y directions is the conductivity at a direction orthogonal to the z direction. The conductivity at the x and y directions is also called lateral conductivity of the layer or the film. FIG. 1 illustrates the conductivity at z direction and at the x and y directions of a layer or a film 130.

The present invention provides a dispersion composition comprising a filler, a polymerizable monomer or oligomer, and an additive comprising a polycyclic aromatic group.

The polymerizable monomer or oligomer comprises at least one polymerizable group such as acrylate, methacrylate, polyacrylate, polymethacrylate, vinyl acrylate, vinyl methacrylate, styrene, methylstyrene, epoxy, isocyanate, carboxylic acid, carboxylic acid halide, hydroxy, thiol, amine, silane, and mixtures thereof.

The filler of the dispersion composition may be carbon nanotube, carbon nanofibers, graphene, carbon black, and mixtures thereof. Such fillers when present in polymer films or polymer parts can increase the conductivity, the mechanical strength of the corresponding polymer film or polymer part. They may also improve the barrier properties of the corresponding polymer film or polymer part, that is, they prevent oxygen, water or moisture, and other molecules to penetrate the polymer film or the polymer part. The content of the filler in the dispersion composition may be from 0.001 weight percent to 20 weight percent by weight of the dispersion composition, or from 0.01 weight percent to 15 weight percent, or from 0.1 weight percent to 10 weight percent, or from 0.2 weight percent to 5 weight percent by weight of the dispersion composition.

Carbon black fillers can be of the conductive type or of the nonconductive type, depending on the application and the desired benefit. Conductive carbon black materials are typically high specific surface area solid particles that form a network of connected particle structures. Microporosity in carbon black particles also improves the conductivity. The specific surface area of conductive carbon black particles is higher than 120 m²/g, or higher than 250 m²/g, or higher than 800 m²/g, measured via BET methodology (nitrogen adsorption on particle surface). Non-conductive carbon black fillers are typically used to color polymer films and polymer parts. However, if the particle specific surface area is sufficiently high, the corresponding polymer films and polymer parts may exhibit improved mechanical strength and barrier properties. To provide improved mechanical strength and barrier properties, a high specific surface area of the filler and high quality dispersion of the filler in the polymer is preferred. For polymer films and polymer parts having high mechanical strength and/or good barrier properties, the specific surface area of the carbon black is higher than 250 m²/g, or higher than 800 m²/g, measured via BET methodology (nitrogen adsorption on particle surface).

Carbon nanotube fillers can be single-wall carbon nanotubes (SWCNT) or multi-wall carbon nanotubes (MWCNT), which are cylindrical particles with typical diameter of less than 100 nm. They are conductive fillers with high specific surface area. Well-dispersed carbon nanotube in polymer films and polymer parts may increase the conductivity of such polymer films and polymer parts. They may also improve both the mechanical strength and the barrier properties of such polymer films and polymer parts.

Carbon nanofibers, also called graphite fibers, have typically a diameter of 5-10 μm and a very large aspect ratio. As with carbon black and carbon nanotubes, carbon nanofiber filler can increase conductivity of polymer films and polymer parts, and improve barrier properties and mechanical strength of polymer films and polymer parts.

Graphene is an allotrope of carbon that exists as a two-dimensional sheet. This sheet is a monolayer of carbon atoms. As a filler in a polymer film or polymer part, graphene can increase conductivity of polymer films and polymer parts, and improve barrier properties and mechanical properties such as stiffness and rigidity. The specific surface area of graphene may be from 300 m²/s to 2600 m²/s.

The additive of the dispersion composition of the invention comprises a polycyclic aromatic group. The additive is represented by Formula I.

R1—(CH₂)ₙ—Y—Z Formula I

In Formula I, R1 is a polycyclic aromatic group comprising from 10 to 24 aromatic atoms, the aromatic atoms being selected from the group consisting of carbon, nitrogen, oxygen, and sulfur; n is 0, 1, 2, 3, 4, 5, 6, 7 or 8. In Formula I, Y is a functional group selected from the group consisting of ester, thioester, amide, urea, thiourea, carbamate, S-thiocarbamate, beta hydroxyester, -Q-CR2R3—CR4(OH)—, and -Q-SiR5R6—, Q being O, NH or S; R2, R3, R4 being independently hydrogen, or linear or branched alkyl group having 1-6 carbon atoms; R5, R6 being independently alkyl groups having 1-4 carbon atoms. In Formula I, Z is a group comprising a reactive functional group, the reactive functional group being selected from the group consisting of acrylate, methacrylate, styrene, methyl styrene, epoxy, isocyanate, hydroxy, thiol, carboxylic acid, carboxylic acid halide, silane, and amine. The reactive functional group is able to participate in a polymerization reaction of the polymerizable monomer or oligomer.

The polyclic aromatic group may comprise from 10 to 14 aromatic atoms, or from 10 to 16 aromatic atoms, or from 10 to 18 aromatic atoms, or from 12 to 14 aromatic atoms, or from 12 to 16 aromatic atoms, or 12 to 18 atromatic atoms, or 16 to 22 aromatic atoms, or 16 to 24 aromatic atoms, or 19 to 24 aromatic atoms. All the aromatic atoms of the polycyclic aromatic group may be carbon atoms. The polycyclic aromatic group may also comprise heteroatoms, such as oxygen, sulfur, or nitrogen aromatic atoms.

The polycyclic aromatic group may be an aromatic system selected from the group consisting of naphthalene, acenaphthylene, acenaphthene, phenalene, fluorene, phenanthrene, anthracene, fluoroanthene, carbazole, dibenzofuran, dibenzothiophene, acridine, xanthene, thioxanthene, benzo[c]fluorene, benz[a]anthracene, pyrene, triphenylene, chrysene, tetracene, pentacene, benzo[a]pyrene, benz[e]acephenanthrylene, benzo[k]fluoranthene, benzo[j]fluoranthene, dibenzo[a,h]anthracene, perylene, coronene, corannulene, benzo[ghi]perylene, dibenzo[a,e]pyrene, dibenzo[a,h]pyrene, dibenzo[a,i]pyrene, dibenzo[a,l]pyrene, indeno[1,2,2-c,d]pyrene, and porphyrin.

The additive may be also comprise, in addition to the polycyclic aromatic group, the following groups: 1-(acryloyloxy)methyl, 1-(methacryloyloxy)methyl, 2-(acryloyloxy)ethyl, 2-(methacryloyloxy)ethyl, 3-(acryloyloxy)propyl, 3-(methacryloyloxy)propyl, 4-(acryloyloxy)butyl, 4-(methacryloyloxy)butyl. These groups are represented by the structures of Formulas II to IX.

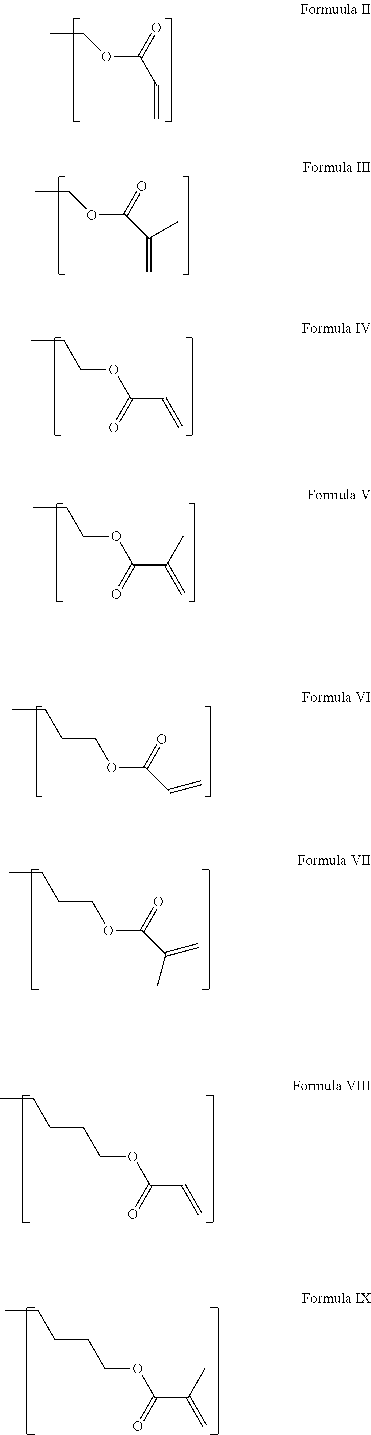

The substituent of the polycyclic aromatic compound may also be acrylate, methacrylate, 5-(acryloyloxy)pentyl and 5-(methacryloyloxy)pentyl.

The polycyclic aromatic group may comprise another substituent R8 directly bonded to an aromatic ring of the polycyclic aromatic compound. Substituent R8 may be an alkyl group, a halogen-substituted alkyl, a hydroxyalkyl, an alkenyl, and a halogen, wherein the alkyl, the halogen-substituted alkyl, the hydroxyalkyl, and the alkenyl group, comprises from 1 to 8 carbon atoms. Non-limiting examples of substituents R3 are methyl, ethyl, propyl, butyl, pentyl, hexyl, heptyl, octyl, chloro, fluoro, bromo, chloromethyl, 1-chloroethyl, 2-chloroethyl, 1-chloropropyl, 2-chloropropyl, 3-chloropropyl, 1-chlorobutyl, 2-chlorobutyl, 3-chlorobutyl, 4-chlorobutyl, hydroxymethyl, 1-hydroxyethyl, 2-hydroxyethyl, 1-hydroxypropyl, 2-hydroxypropyl, 3-hydroxypropyl, 1-hydroxybutyl, 2-hydroxybutyl, 3-hydroxybutyl, and 4-hydroxybutyl.

Non-limiting examples of additives the dispersion composition of the present invention include 1-pyrenyl acrylate, 1-pyrenyl methacrylate, 2-pyrenyl acrylate, 2-pyrenyl methacrylate, 1-pyrenylmethyl acrylate, 1-pyrenylmethyl methacrylate, 2-pyrenylmethyl acrylate, 2-pyrenylmethyl methacrylate, 2-(1-pyrenyl)ethyl acrylate, 2-(1-pyrenyl)ethyl methacrylate, 2-(2-pyrenyl)ethyl acrylate, 2-(2-pyrenyl)ethyl methacrylate, 3-(1-pyrenyl)propyl acrylate, 3-(1-pyrenyl)propyl methacrylate, 3-(2-pyrenyl)propyl acrylate, 3-(2-pyrenyl)propyl methacrylate, 4-(1-pyrenyl)butyl acrylate, 4-(1-pyrenyl)butyl methacrylate, 4-(2-pyrenyl)butyl acrylate, 4-(2-pyrenyl)butyl methacrylate, 5-(1-pyrenyl)pentyl acrylate, 5-(1-pyrenyl)pentyl methacrylate, 5-(2-pyrenyl)pentyl acrylate, and 4-(2-pyrenyl)pentyl methacrylate. The examples of the compounds that correspond to 1-pyrene derivatives are represented by the following formula X and XI. In these formulas n can be 0, 1, 2, 3, 4, 5, 6, 7 or 8.

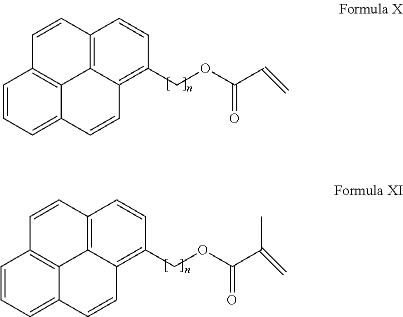

Other non-limiting examples of additive of the dispersion composition of the present invention include 11-naphthalenyl 2-propenoate, 1-naphthalenyl 2-methyl 2-propenoate, 2-naphthalenyl 2-propenoate, 2-naphthalenyl 2-methyl 2-propenoate, 1-naphthylmethyl acrylate, 1-naphthylmethyl methacrylate, 2-naphthylmethyl acrylate, 2-naphthylmethyl methacrylate, 2-(1-naphthyl)ethyl acrylate, 2-(1-naphthyl)ethyl methacrylate, 2-(2-naphthyl)ethyl acrylate, 2-(2-naphthyl)ethyl methacrylate, 3-(1-naphthyl)propyl acrylate, 3-(1-naphthyl)propyl methacrylate, 3-(2-naphthyl)propyl acrylate, 3-(2-naphthyl)propyl methacrylate, 4-(1-naphthyl)butyl acrylate, 4-(1-naphthyl)butyl methacrylate, 4-(2-naphthyl)butyl acrylate, 4-(2-naphthyl)butyl methacrylate, 5-(1-naphthyl)pentyl acrylate, 5-(1-naphthyl)pentyl methacrylate, 5-(2-naphthyl)pentyl acrylate, and 4-(2-naphthyl)pentyl methacrylate.

Other non-limiting examples of additive of the dispersion composition of the present invention include 1-anthracenyl 2-propenoate, 1-anthracenyl 2-methyl 2-propenoate, 2-anthracenyl 2-propenoate, 2-anthracenyl 2-methyl 2-propenoate, 9-anthracenyl 2-propenoate, 9-anthracenyl 2-methyl 2-propenoate, 1-anthracenylmethyl acrylate, 1-anthracenylmethyl methacrylate, 2-anthracenylmethyl acrylate, 21-anthracenylmethyl methacrylate, 9-anthracenylmethyl acrylate, 9-anthracenylmethyl methacrylate, 2-(1-anthracenyl)ethyl acrylate, 2-(1-anthracenyl)ethyl methacrylate, 2-(2-anthracenyl)ethyl acrylate, 2-(2-anthracenyl)ethyl methacrylate, 2-(9-anthracenyl)ethyl acrylate, 2-(9-anthracenyl)ethyl methacrylate, 3-(1-anthracenyl)propyl acrylate, 3-(1-anthracenyl)propyl methacrylate, 3-(2-anthracenyl)propyl acrylate, 3-(2-anthracenyl)propyl methacrylate, 3-(9-anthracenyl)propyl acrylate, 3-(9-anthracenyl)propyl methacrylate, 4-(1-anthracenyl)butyl acrylate, 4-(1-anthracenyl)butyl methacrylate, 4-(2-anthracenyl)butyl acrylate, 4-(2-anthracenyl)butyl methacrylate, 4-(9-anthracenyl)butyl 1 acrylate, 4-(9-anthracenyl)butyl methacrylate, 5-(1-anthracenyl)pentyl acrylate, 5-(1-anthracenyl) pentyl methacrylate, 5-(2-anthracenyl) pentyl acrylate, 5-(2-anthracenyl)pentyl methacrylate, 5-(9-anthracenyl) pentyl acrylate, 5-(9-anthracenyl) pentyl methacrylate

Other non-limiting examples of additive of the dispersion composition of the present invention include (1-Phenanthryl)methyl acrylate, (1-Phenanthryl)methyl methacrylate, (2-Phenanthryl)methyl methacrylate, (2-Phenanthryl)methyl acrylate, (3-Phenanthryl)methyl methacrylate, (3-Phenanthryl)methyl acrylate, (4-Phenanthryl)methyl methacrylate, (4-Phenanthryl)methyl acrylate, (5-Phenanthryl)methyl methacrylate, (5-Phenanthryl)methyl acrylate.

Potential synthetic routes for synthesizing the additive that can be used in the dispersion composition of the present invention include starting materials with molecular structures comprising a polycyclic aromatic group and a reactive functional group A, for example hydroxy, thiol, or amine functional groups directly bonded to a polycyclic aromatic atom. Functional group A may also be carboxylic acid, carboxylic acid halide, isocyanate, epoxy, and silane. Examples of such starting materials include 1-naphthol, 2-naphthol, 2-hydroxyanthracene, anthracenol. anthranol, 1-aminonthracene, 1-pyrenol, 2-pyrenol, and similar compounds. Other appropriate starting materials include compounds that comprise a polycyclic aromatic group and an alkylhydroxy, alkylamino, or alkylthio substituent attached to an aromatic atom. Non-limiting examples of such substituents include —CH₂OH, —CH₂CH₂OH, —CH₂CH₂CH₂OH, —CH₂CH₂CH₂CH₂OH, —CH₂CH₂CH₂CH₂CH₂OH, —CH₂CH₂CH₂CH₂CH₂CH₂OH, —CH₂CH₂CH₂CH₂CH₂CH₂CH₂OH, —CH₂CH₂CH₂CH₂CH₂CH₂CH₂CH₂OH, —CH₂SH, —CH₂CH₂SH, —CH₂CH₂CH₂SH, —CH₂CH₂CH₂CH₂SH, —CH₂CH₂CH₂CH₂CH₂SH, —CH₂CH₂CH₂CH₂CH₂CH₂SH, —CH₂CH₂CH₂CH₂CH₂CH₂CH₂SH, —CH₂CH₂CH₂CH₂CH₂CH₂CH₂CH₂SH, —CH₂NH₂, —CH₂CH₂NH₂, —CH₂CH₂CH₂NH₂, —CH₂CH₂CH₂CH₂NH₂, —CH₂CH₂CH₂CH₂CH₂CH₂NH₂, —CH₂CH₂CH₂CH₂CH₂CH₂CH₂NH₂, —CH₂CH₂CH₂CH₂CH₂CH₂CH₂CH₂NH₂, etc. The polycyclic aromatic starting material may then react with a reagent that has (a) a functional group B that can react can react with functional group A of the polycyclic aromatic starting material, and (b) a polymerizable functional group C. Non-limiting examples of functional group B include acid halide, isocyanate, epoxide, silane, carboxylic acid, amine, hydroxy, and thiol. Table 1 includes examples of various combinations of functional groups A and B and the group formed from the reaction between functional group A and B.

TABLE 1
Examples of Reactions for the Preparation of the Additive.

| Functional Group A of | Functional Group B | |
|---|---|---|
| polycyclic aromatic | of the reagent | |
| starting material | OR | |
| OR | Functional Group A of | |
| Functional Group B | polycyclic aromatic | Resulting functional group in |
| of the reagent | starting material | the additive |
| Hydroxy | Acid halide | Ester-O—C(O)— |
| Thiol | Acid halide | Amide-NH—C(O)— |
| Amine | Acid halide | Thioester-S—C(O)— |
| Hydroxy | Isocyanate | Carbamate-O—C(O)—NH— |
| Thiol | Isocyanate | S-Thiocarbamate-S—C(O)—NH— |
| Amine | Isocyanate | Urea-NH—C(O)—NH— |
| Hydroxy | Epoxy | —OCR2R3-CR4(OH)— |
| Thiol | Epoxy | —SCR2R3-CR4(OH)— |
| Amine | Epoxy | —NH-CR2R3-CR4(OH)— |
| Hydroxy | Silane-(OR)₃-Si-R5R6- | —O-SiR5R6- |
| Thiol | Silane ″ | —S-SiR5R6- |
| Amine | Silane ″ | —NH-SiR5R6- |
| Carboxylic acid | Hydroxy | Ester |
| Carboxylic acid | Thiol | Thioester |
| Carboxylic acid | Amine | Amide |
| Carboxylic acid | Epoxy | Beta hydroxyester |

The structure of epoxy may be represented by Formula XII.

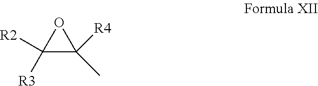

The polymerizable monomer or oligomer of the dispersion composition is a compound that can be polymerized via a curing mechanism. The curing process may include a variety of curing species including the polymerizable monomer or oligomer, a crosslinking agent, a chain-extending reagent, and an initiator. The polymerizable monomer or oligomer of the dispersion composition may comprise at least one carbon-carbon double bond. In the present invention, the additive also participates in the curing process. Specifically, the reactive functional group of the additive reacts with one or more curing species, e.g., a polymerizable monomer or oligomer, a crosslinking reagent, and a chain-extending reagent. In some embodiments, the reactive functional group of the additive reacts with a curing species to form a cured moiety such as a crosslink, a thermoplastic linkage, a bond between two types of polymerizable monomers or oligomers and the like in a resulting polymer. In certain embodiments, the reactive functional group of the additive reacts with a reactive functional group of curing species such as a crosslinking reagent to form a crosslink. In some cases the reactive functional group of the additive may be configured to react with a reactive functional group of a curing species under a particular set of conditions, e.g., at a particular range of temperatures or under ultraviolet light. In some embodiments, the reactive functional group of the additive may react under certain conditions such that composition undergoes thermoplastic drying. Non-limiting examples of reactive functional groups include hydroxyls, carbonyls, aldehydes, carboxylates, amines, imines, imides, azides, ethers, esters, sulfhydryls (thiols), silanes, nitriles, carbamates, imidazoles, pyrrolidones, carbonates, vinyl, acrylates, alkenyls, and alkynyls. Other reactive functional groups are also possible and those skilled in the art would be capable of selecting suitable reactive functional groups for use with dual cure compositions, based upon the teachings of this specification.

In some embodiments, the reactive functional group of the additive reacts with the curing species in the presence of a stimulus such as electromagnetic radiation (e.g., visible light, UV light, etc.), an electron beam, increased temperature (e.g., such as utilized during solvent extraction or condensation reactions), a chemical compound (e.g., thiolene), and/or a crosslinker. For example, a dispersion composition comprising vinyl acrylate monomers or oligomers may be polymerized on a substrate via UV irradiation in a presence of a photoinitiator. The additive of the present invention participates in the polymerization along with the vinyl acrylate monomers or oligomer and it becomes part of the resulting polymer.

Non-limiting examples of general types of polymers formed by the polymerizable monomer or the oligomer of dispersion composition include polyurethane, polyethylene, polypropylene, polyacrylate, polymethacrylate, PET, PVC, polyvinyl alcohol, polycarbonate, polyester, polyamide, polystyrene, polyvinyl acrylate, polyvinyl methacrylate and their copolymers. Polyacrylates and polymethacrylates may also be formed from acrylated epoxies, methacrylated epoxies, acrylated polyesters, methacrylated polyesters, acrylated urethanes, methacrylated urethanes, acrylated silicones, methacrylated silicones, and other.

The content of the polymerizable monomer or oligomer in the dispersion composition may be from 0.5 weight percent to 99 weight percent by weight of the dispersion composition, or from 1 weight percent to 95 weight percent, or from 2 weight percent to 90 weight percent, or from 5 weight percent to 85 weight percent by weight of the dispersion composition.

The dispersion composition may further comprise a liquid carrier, which can be an aqueous or a non-aqueous carrier. The liquid carrier enables the composition to be a liquid. In the absence of a liquid carrier, the polymerizable monomer or oligomer may serve this role. The aqueous carrier comprises water. It may further comprises water-miscible co-solvent and/or a surfactant. Non-limiting examples of water miscible solvents are dipropylene glycol, tripropylene glycol, diethylene glycol, ethylene glycol, propylene glycol, glycerin, 1,3-propane diol, 2,2-propanediol, 1,2-butanediol, 1,3-butanediol, 1,4-butanediol, 2,3-butanediol, 2-methyl-2,4-pentanediol, and mixtures thereof. The non-aqueous carrier may be any organic solvent or other organic liquid. The non-aqueous carrier may also be a silicone solvent or a silicone fluid. The liquid carrier may be the same as the polymerizable monomer or oligomer. The content of the liquid carrier in the dispersion composition may be from 0.5 weight percent to 99 weight percent by weight of the dispersion composition, or from 1 weight percent to 95 weight percent, or from 2 weight percent to 90 weight percent, or from 5 weight percent to 85 weight percent by weight of the dispersion composition.

The dispersion composition of the present invention can be used to form a polymer film. The polymer film may be a conductive film, a barrier film, an electrode, a binder layer for encapsulated electro-optic medium layer, a sealing layer, an edge seal, or an adhesive layer.

The dispersion composition of the present invention can be used to form an adhesive an adhesive layer. Adhesive compositions for laminate structures are generally known. Adhesive compositions are used to form adhesive layers that adhere together different layers of the laminate structure. Such adhesive compositions may comprise, for example, hot-melt type adhesives and/or wet-coat adhesives, such as polyurethane-based adhesives.

An electro-optic assembly is a laminate structure and may comprise an adhesive layer. The adhesive layer of an electro-optic assembly must meet certain requirements in relation to its mechanical, thermal and electrical properties. The selection of a lamination adhesive for use in an electro-optic display presents certain problems. Because the lamination adhesive is normally located between the electrodes, which apply the electric field needed to change the electrical state of the electro-optic medium, the conductive properties of the adhesive may significantly affect the electro-optic performance of the display.

The volume resistivity of the lamination adhesive influences the overall voltage drop across the electro-optic medium, which is a critical factor in the performance of the medium. The voltage drop across the electro-optic medium is equal to the voltage drop across the electrodes, minus the voltage drop across the lamination adhesive. On one hand, if the volume resistivity of the adhesive layer is too high, a substantial voltage drop will occur within the adhesive layer, requiring higher voltages between the electrodes to produce a working voltage drop at the electro-optic medium. Increasing the voltage across the electrodes in this manner is undesirable, because it increases power consumption, and may require the use of more complex and expensive control circuitry to produce and switch the increased voltages. On the other hand, if the volume resistivity of the adhesive layer is too low, there will be undesirable cross talk between adjacent electrodes (i.e., active matrix electrodes) or the device may simply short out. Furthermore, because the volume resistivity of most materials decreases rapidly with increasing temperature, if the volume resistivity of the adhesive is too low, the performance of the display will vary greatly with temperatures substantially above room temperature.

For these reasons, there is an optimum range of volume resistivity values of adhesive layers for use with most electro-optic media, this range varying with the volume resistivity of the electro-optic medium. The volume resistivities of encapsulated electrophoretic media are typically around 10¹⁰ Ohm·cm, and the volume resistivities of other electro-optic media are usually of the same order of magnitude. Accordingly, for good electro-optic performance, the volume resistivity of the lamination adhesive is preferably in the range of about 10⁸ Ohm·cm to about 10¹² Ohm·cm, or about 10⁹ Ohm·cm to about 10¹¹ Ohm·cm, at an operating temperature of the display of around 20° C. Preferably, the lamination adhesive will also have a variation of volume resistivity with temperature that is similar to the electro-optic medium itself. The values correspond to measurements after being conditioned for one week at 25° C. and 50% relative humidity. In addition to the electrical properties, the lamination adhesive must fulfill several mechanical and rheological criteria, including strength of adhesive, flexibility, ability to withstand and flow at lamination temperatures, etc.

One way to mitigate the voltage drop described above is the addition of ionic dopants, such as inorganic or organic salts, including ionic liquids, into the adhesive composition. Dopants may be also added into the electro-optic layer that can also enhance the low temperature performance. For example, to improve the performance of commercially available polyurethane adhesive compositions, the compositions can be doped with salts or other materials. An example of such a dopant is tetrabutylammonium hexafluorophosphate. However, with experience it was discovered that some adhesive compositions formulated with such dopants might damage active matrix backplanes, especially those including transistors made from organic semiconductors, In addition, as it is described above, the mobility of such dopants, especially at higher temperatures, may negatively affect electro-optic performance of the device by increasing blooming. Conductive filler may also be used in adhesive compositions to control the volume resistivity of the corresponding adhesive layers. However, to be effective, the conductive filler must be present in the adhesive layer in a dispersed form. Thus, they are predispersed. Typically, the preparation of the predispersion requires the use of surfactants that wet and stabilize the conductive filler particles in the predispersion carrier. Such surfactants may cause problems of increased blooming, because they are also mobile in the adhesive layer. This problem can be solved by using the dispersion composition of the present invention that comprises a conductive filler and an additive. In this case, the additive, which is used during the preparation of the predispersion, eventually becomes part of the polymer matrix of the adhesive layer. Thus, the additive is not mobile in the polymer matrix, The presence of the additive may eliminate the need for a traditional surfactant or, at least, it may reduce the required quantity of the traditional surfactant for the preparation and stabilization of the predispersion that comprises the conductive filler.

A technique to mitigate the blooming of an electro-optic device without significantly affecting its energy consumption is by forming an adhesive layer that has anisotropic conductivity. That is, by creating an adhesive layer that exhibits conductivity at the z direction higher than the conductivity at the x and y directions. As defined above and illustrated in FIG. 1, z direction of a layer is the direction perpendicular to the plane of the adhesive layer. The x and y directions are orthogonal to the z direction. The conductivity at the x and y directions (direction of the plane of the layer) is called lateral conductivity. High lateral conductivity of the corresponding adhesive layer causes increased blooming. Anisotropic conductivity of a layer may be created by the appropriate aligning of conductive filler particles before the curing of the layer. Various aspects of this technique have been disclosed in the art, for example, in U.S. Patent Application No. 2015/0176147, U.S. Pat. Nos. 7,535,624, 7,843,626, 10,613,407, 10,090,076, and 9,780,354, PCT Application No. WO2012/081992, which are incorporated by reference in their entirety herein. An example of a process of forming a layer having anisotropic conductivity involves the steps of (a) preparing a dispersion composition comprising conductive filler particles and a polymerizable monomer or oligomer, (b) applying a wet film of the dispersion composition on a substrate, (c) applying an electric field across the wet film to align the conductive filler particles, and (d) curing the dispersion composition. For the effective formation of a layer having anisotropic conductivity (at the z direction), the concentration of the conductive filler in the layer should be lower than the percolation threshold. Percolation threshold of a filler in a polymer matrix is defined as the minimum filler concentration in a polymer matrix after which there is no significant change in the electrical properties of the matrix. The conductive filler particles may also have magnetic properties. In this case, the conductive filler particles may be aligned in the wet film upon application of a magnetic field across the wet film before the curing step. Alignment of the conductive filler particles followed by curing of the layer results is anisotropic conductivity of the layer at the z direction, because the conductive particles are immobilized in the aligned configuration at the polymer matrix,

The inventive dispersion composition may be cured by different mechanisms to produce a polymer film. The polymer film may serve as an adhesive layer. Examples of curing mechanisms include, thermal, chemical and/or via light activation. Depending on the curing mechanism, the dispersion composition may comprise other material, in addition to the polymerizable monomer or oligomer, the filler, and the additive.

The dispersion composition of the present invention may also be used in other parts of the electro-optic assembly, such, for example, the binder of the electro-optic material layer. The dispersion composition of the present invention can provide improved electro-optic performance, when it is used to form an adhesive layer and/or a binder of the electro-optic material layer of the electro-optic assembly.

The dispersion composition of the present invention may further comprise a polyurethane. The polyurethane may be present in a form of a polyurethane solution or a polyurethane dispersion in an aqueous or non-aqueous medium. Generally, polyurethanes are prepared via a polymerization process involving a diisocyanate and a polyol or diol.

The dispersion composition of the present invention may comprise a blend of polymerizable monomers or oligomers. The blend of polymerizable monomers or oligomers may comprise soluble materials (in molecular form) or non-soluble materials (particles or droplets), or a combination of soluble and non-soluble materials. In some embodiments, the resulting polymer film or polymer part may be formed from the dispersion composition by synthetic polymerization processes, where one component is polymerized in the presence of a second polymeric component, or both polymers may be formed simultaneously. In some cases, the dispersion composition may comprise emulsifying polymerizable monomers or oligomers.

The polymerizable monomer or oligomer of the dispersion composition may comprise two or more reactive functional groups. The reactive functional groups may be positioned as end groups, along the backbone, or along chains extended from the backbone.

Reactive functional groups generally refer to functional groups configured to react with one or more curing species, e.g., a crosslinking reagent, a chain-extending reagent, etc. In some embodiments, the reactive functional group reacts with a curing species to form a cured moiety such as a crosslink, a thermoplastic linkage, a bond between two types of polymeric materials, or the like. In certain embodiments, a reactive functional group may react with a curing species such as a crosslinking reagent to form a crosslink. In some cases, a reactive functional group may be configured to react with another reactive functional group under a particular set of conditions, e.g., at a particular range of temperatures. In some embodiments, a reactive functional group may react under certain conditions such that the adhesive material undergoes thermoplastic drying. Non-limiting examples of reactive functional groups include hydroxyls, carbonyls, aldehydes, carboxylates, amines, imines, imides, azides, ethers, esters, sulfhydryls (thiols), silanes, nitriles, carbamates, imidazoles, pyrrolidones, carbonates, acrylates, alkenyls, and alkynyls. Other reactive functional groups are also possible and those skilled in the art would be capable of selecting suitable reactive functional groups for use with dual cure adhesives, based upon the teachings of this specification. Those skilled in the art would also understand that the curing steps described herein do not generally refer to the formation of an adhesive material, e.g., polymerization of an adhesive backbone such as a polyurethane backbone, but the further reaction of an adhesive material such that the adhesive material forms crosslinks, undergoes thermoplastic drying, or the like such that the adhesive undergoes a substantial change in mechanical properties, viscosity, and/or adhesiveness.

In some embodiments, the functional reactive group reacts with the curing species in the presence of a stimulus such as electromagnetic radiation (e.g., visible light, UV light, etc.), an electron beam, increased temperature (e.g., such as utilized during solvent extraction or condensation reactions), a chemical compound (e.g., thiolene), and/or a crosslinker. For example, an adhesive composition comprising vinyl acrylate monomers or oligomers may be polymerized on a substrate via UV irradiation in a presence of a photoinitiator. The additive of the composition may be polymerized along with the vinyl acrylate monomers or oligomer and be part of the same polymer.

In another aspect, the dispersion composition may also comprise a crosslinker. The crosslinker may comprise a functional group selected from the group consisting of isocyanate, epoxy, hydroxyl, aziridine, amine, and combinations thereof. Non-limiting examples of crosslinkers include 1,4-cyclohexanedimethanol diglycidyl ether (CHDDE), neopentyl glycol diglycidyl ether (NGDE), O,O,O-triglycidyl glycerol (TGG)), homopolymers and copolymers of glycidyl methacrylate, and N,N-diglycidylaniline. In some embodiments, the adhesive comprising a crosslinker may be crosslinked upon exposure to an activation temperature of the crosslinking agent. The crosslinker may be present in the dispersion composition in a concentration of between about 100 ppm and about 15,000 ppm by weight of the dispersion composition.

The dispersion composition of the present invention, comprising a filler, a polymerizable monomer or oligomer, and an additive represented by Formula I, can be used to form an adhesive layer in an electro-optic assembly. The electro-optic assembly may be a front plane laminate comprising in order (a) a first electrode layer, (b) an electro-optic material layer, (c) a first adhesive layer, and (d) a release sheet. The front plane laminate can be converted to an electro-optic device by removing the release sheet and connecting a second electrode layer onto the exposed first adhesive layer. The first electrode layer may comprise a light- transmissive electrically-conductive layer.

The dispersion composition of the present invention can be used to form an adhesive layer in an electro-optic assembly, wherein the electro-optic assembly is an inverted front plane laminate. The inverted front plane laminate comprises in order (i) a first electrode layer, (ii) a first adhesive layer, (iii) an electro-optic material layer, and (iv) and a release sheet. The inverted front plane laminate may also comprise a second adhesive layer between the electro-optic material layer and the electro-optic material layer. The inverted front plane laminate can be converted to an electro-optic device by removing the release sheet and connecting a second electrode layer onto the exposed electro-optic material layer (or onto the second adhesive layer. The first adhesive layer may be formed by the dispersion composition of the present invention. The second adhesive layer may also be formed by the dispersion composition of the present invention.

The dispersion composition of the present invention can be used for forming polymer parts or polymer films. Composites materials comprising a polymer and high surface area fillers are known to form polymer parts and polymer films with good mechanical strength and/or good barrier properties. For example, a polymer composite comprising content of 0.1-0.5 weight percent of carbon nanotubes in polypropylene exhibits good stiffness (measured as Young's modulus) compared to the corresponding polymer without the filler. These composites are very attractive as parts for engines, structural parts for architecture, furniture, etc. because of their improved strength and their lightness (low density compared to metals). The polymers can be thermoplastic, thermosetting or elastomeric. However, it is difficult to disperse carbon nanotubes and other high surface area fillers in polymers. Lower quality dispersion provide much less efficient mechanical strength benefits. Good dispersion is improved by the preparation of predispersions (masterbatch) of carbon nanotubes in lower molecular weight polymers, surfactants or combinations thereof. The typical process includes the initial preparation of a predispersion as a high concentration of the filler in a low molecular carrier and/or a surfactant or dispersant. However, even a small percentage of such a low molecular carrier and/or a surfactant or dispersant material in the final polymer part is detrimental to the mechanical strength of the polymer part or polymer film. The polymer part or polymer film is typically formed by mixing the predispersion with the polymeric material and molding of the mixture of the polymer-predispersion. The masterbatch may be prepared in a kneader or a twin-screw extruder, in case of a solid. Alternatively, a liquid predispersion may be prepared in a medial mill, if it is a liquid. The dispersion composition of the present invention can enable the reduction, or even elimination, of the lower molecular weight polymer and/or the surfactant for making a predispersion for the polymer part.

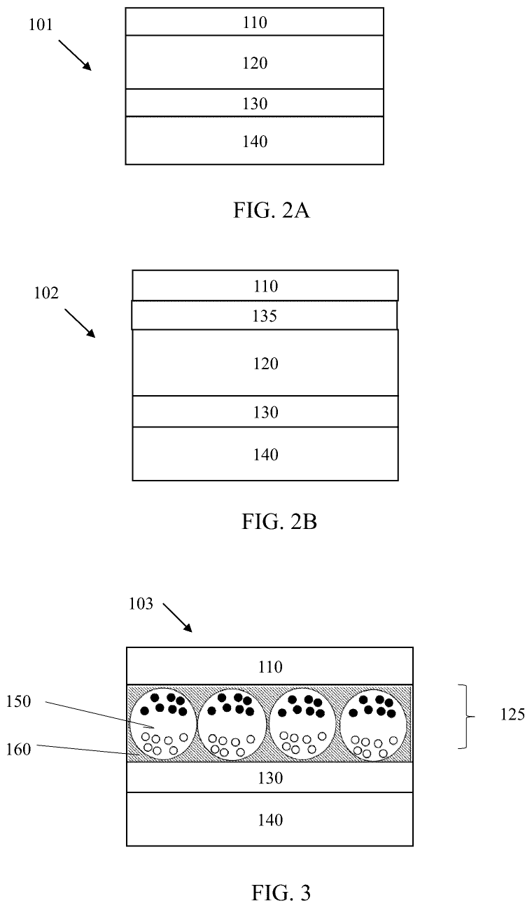

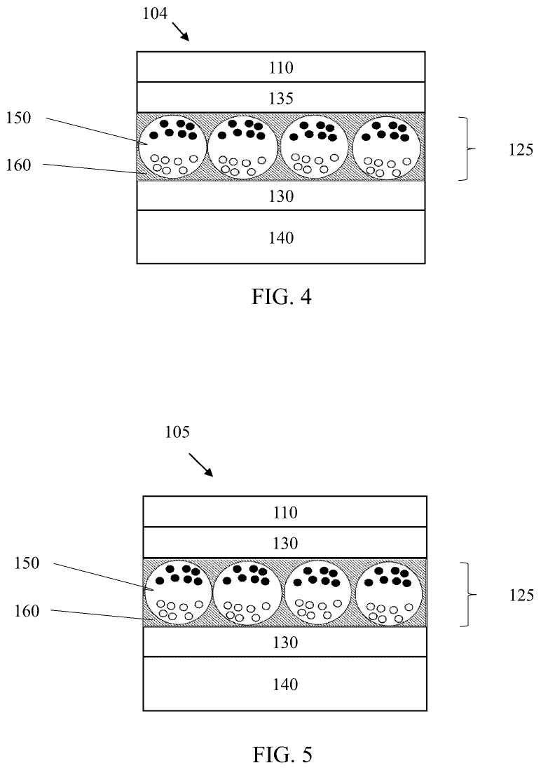

As illustrated in FIG. 2A, in some embodiments, an electro-optic device 101 comprises a first electrode layer 110, an electro-optic material layer 120, and a second electrode layer 140. Different layers of the assembly are joined together with an adhesive layer formed by the dispersion composition. In FIG. 2A, second electrode layer 140 is adhered to the electro-optic material layer by first adhesive layer 130. In some embodiments, as illustrated in FIG. 2B, more than one adhesive layers are present in electro-optic device 102. Specifically, in this example, second electrode layer 140 is adhered to the electro-optic material layer 120 by first adhesive layer 130, and first electrode 110 is adhered to electro-optic material layer 120 by second adhesive layer 135, which may comprise the same or different materials as first adhesive layer 130. As illustrated in electro-optic device 103 of FIG. 3, an electro-optic material layer 125 may comprise capsules 150 and a binder 160. The capsules 150 may encapsulate one or more types of particles that can be caused to move through the capsule via application of an electric field across the electro-optic material layer 125. In some embodiments, first electrode layer 110 may be directly adjacent to electro-optic material layer 125, and second electrode layer 140 is adhered to the electro-optic material layer by first adhesive layer 130. In an exemplary embodiment, as illustrated in electro-optic assembly 104 of FIG. 4, second electrode layer 140 may be adhered to electro-optic material layer 125 by first adhesive layer 130 and first electrode layer 110 may be adhered to electro-optic material layer 125 by second adhesive layer 135. In another exemplary embodiment, as illustrated in electro-optic assembly 105 of FIG. 5, first electrode layer 110 may be adhered to electro-optic material layer 125 by second adhesive layer 130 and second electrode 140 may be adhered to electro-optic material layer 125 by first adhesive layer 130. In this case, the dispersion compositions that form the first and second adhesive layers are the same.

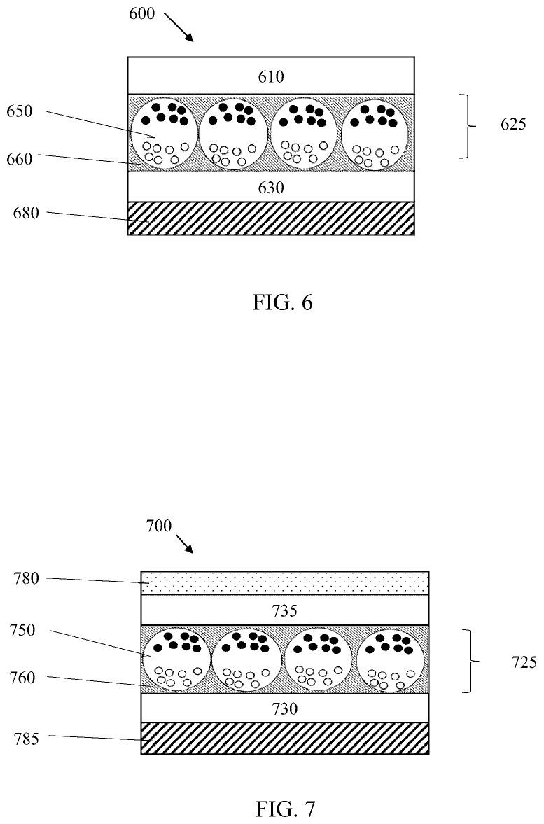

Adhesive layers that are formed by a dispersion composition of the present invention may be used for electro-optic assemblies, such as a front plane laminate and a double release sheet. As illustrated in FIG. 6, in some embodiments, a front plane laminate 600 comprises a first electrode layer 610, an electro-optic material layer 625, and a first release sheet 680. The release sheet 680 is adhered to the electro-optic material layer by first adhesive layer 630. In another embodiment, as illustrated in FIG. 7, a double release sheet 700 comprises two adhesive layers. Specifically, in this example, a first release sheet 785 is attached to the electro-optic material layer 725 using a first adhesive layer 730. A second release sheet 780 is attached to electro-optic material layer 725 using a second adhesive layer 735.

It should be understood that the adhesive layer may be used to adhere any type and number of layers to one or more other layers in the assembly, and the assembly may include one or more additional layers that are not shown in the figures. Additionally, while FIGS. 3, 4 and 5 illustrate an encapsulated electro-optic medium, the adhesive layers are useful in a variety of electro-optic assemblies, such as liquid crystal, frustrated internal reflection, and light-emitting diode assemblies.

In some embodiments, the volume resistivity of the adhesive may range from about 108 ohm·cm to about 1012 ohm·cm, or from about 109 ohm·cm to about 1011 ohm·cm (e.g., at the operating temperature of the assembly around 200° C.). Other ranges of volume resistivity are also possible. The values correspond to measurements after being conditioned for one week at 25° C. and 50% relative humidity. The formed adhesive layer (after curing) may have a particular average coat weight. For example, the adhesive layer may have an average coat weight ranging between 2 g/m² and 25 g/m². In some embodiments, the adhesive layer has an average coat weight of at least 2 g/m², at least 4 g/m², at least about 5 g/m², at least about 8 g/m², at least 10 g/m², at least 15 g/m², or at least 20 g/m². In certain embodiments, the adhesive layer has an average coat weight of less than or equal to 25 g/m², less than or equal to 20 g/m², less than or equal to 15 g/m², less than or equal to 10 g/m², less than or equal to 8 g/m², less than or equal to 5 g/m², or less than or equal to 4 g/m². Combinations of the above-referenced ranges are also possible (e.g., between about 2 g/m² and about 25 g/m², between 4 g/m² and 10 g/m², between 5 g/m² and 20 g/m², between 8 g/m² and 25 g/m²). Other ranges are also possible. The adhesive layer prior to curing may have a particular average wet coat thickness (e.g., such that the adhesive does not significantly alter electrical and/or optical properties of the electro-optic assembly). For example, the adhesive layer can have an average wet coat thickness ranging between 1 microns and 100 microns, between 1 microns and 50 microns, or between 5 microns and 25 microns. In some embodiments, the adhesive layer may have an average wet coat thickness of less than 25 microns, less than 20 microns, less than 15 microns, or less than 12 microns, less than 10 microns, or less than 5 microns. In some embodiments (e.g., in embodiments where the adhesive is wet coated directed to an electro-optic material), the adhesive layer may have an average wet coat thickness between 1 micron and 50 microns, or between 5 microns and 25 microns, or between 5 microns and 15 microns. In some embodiments (e.g., in embodiments where the adhesive is coated onto a layer and then laminated to an electro-optic material), the adhesive layer may have an average wet coat thickness between 15 microns and 30 microns, or 20 microns and 25 microns. Other wet coat thicknesses are also possible.

It should be understood that the adhesive layer may cover the entire underlying layer, or the adhesive layer may only cover a portion of the underlying layer.

Further, the adhesive layer may be applied as a laminate, which usually creates a thicker adhesive layer, or it may be applied as an overcoat, which usually creates a layer that is thinner than a laminate. The overcoat layer may utilize a dual curing system where a first cure occurs prior to overcoat such that the adhesive may be coated on the electro-optic material surface (or another surface) and a second cure sets the material after overcoating. The overcoat layer may be rough if the underlying surface is rough and only a thin layer is applied, or the overcoat layer may be used to planarize an underlying rough surface. Planarization may occur in a single step where the overcoat layer is applied to planarize the rough surface, for example, adding sufficient adhesive to fill in any voids, smooth the surface, and minimally increase the overall thickness. Alternatively, planarization may occur in two steps. The overcoat layer is applied to coat minimally the rough surface and the second coating is applied to planarize. In another alternative, the overcoat layer may be applied to a smooth surface.

Referring again to FIGS. 3, 4 and 5, in some embodiments, the electro-optic assembly comprises electro-optic material layer 125, capsules 150, and binder 160. In certain embodiments, the binder may also be an adhesive, as described above.

In some embodiments, the first electrode layer and/or the second electrode layer comprises one or more sets of electrodes patterned to define the pixels of the display. For example, one set of electrodes may be patterned into elongate row electrodes and another set of electrodes may be patterned into elongate column electrodes running at right angles to the row electrodes, the pixels being defined by the intersections of the row and column electrodes. Alternatively, in some embodiments, one electrode layer has the form of a single continuous electrode and a second electrode layer is patterned into a matrix of pixel electrodes, each of which defines one pixel of the display. In another type of electro-optic display, which is intended for use with a stylus, print head or similar movable electrode separate from the display, only one of the layers adjacent the electro-optic layer comprises an electrode, the layer on the opposed side of the electro-optic layer typically being a protective layer intended to prevent the movable electrode damaging the electro-optic layer.

Referring again to FIGS. 2A, 2B, 3, 3, 4, and 5, first electrode layer 110 may comprise a polymeric film or similar supporting layer (e.g., which may support the relatively thin light-transmissive electrode and protects the relatively fragile electrode from mechanical damage) and second electrode layer 140 comprises a support portion and a plurality of pixel electrodes (e.g., which define the individual pixels of the display). In some cases, the second electrode layer 140 may further comprise non-linear devices (e.g., thin film transistors) and/or other circuitry used to produce on the pixel electrodes the potentials needed to drive the display (e.g., to switch the various pixels to the display states necessary to provide a desired image on the display).

The dispersion composition of the present invention may be prepared by (a) dispersing a composition of a filler, a liquid carrier, and an additive to produce a filler predispersion; (b) adding a polymerizable monomer or oligomer; (c) applying the composition onto a substrate; and (d) curing the applied composition. The dispersing process may be achieved using commercial equipment such as a ball mill, a media mill, an extruder, etc. The liquid carrier may be an aqueous or a non-aqueous carrier.

Alternatively, the polymerizable monomer or oligomer is part of the predispersion. That is, he dispersion composition of the present invention may be prepared by (1) mixing a composition comprising (a) a filler selected from the group consisting of carbon nanotubes, carbon nanofibers, graphene, and carbon black; (b) a polymerizable monomer or oligomer; (c) a liquid carrier; and (d) an additive that is represented by Formula I, wherein R1 is a polycyclic aromatic group comprising from 10 to 24 aromatic atoms, the aromatic atoms being selected from the group consisting of carbon, nitrogen, oxygen, and sulfur; n is 0, 1, 2, 3, 4, 5, 6, 7, or 8; Y is a functional group selected from the group consisting of ester, thioester, amide, urea, thiourea, carbamate, S-thiocarbamate, beta hydroxyester, -Q-CR2R3—CR4(OH)—, and -Q-SiR5R6—; Q being O, NH or S; R2, R3, R4 being independently hydrogen, or linear or branched alkyl group having 1-6 carbon atoms; R5, R6 being independently alkyl groups having 1-4 carbon atoms; and Z is a group comprising a reactive functional group, the reactive functional group being selected from the group consisting of acrylate, methacrylate, styrene, methyl styrene, epoxy, isocyanate, hydroxy, thiol, carboxylic acid, carboxylic acid halide, silane, and amine; (2) applying the composition onto a substrate as a wet film; and (3) curing the applied composition to polymerize the polymerizable monomer or oligomer along with the additive. In this process, the polymerizable monomer or oligomer is part of the composition that has been exposed to the dispersing step.

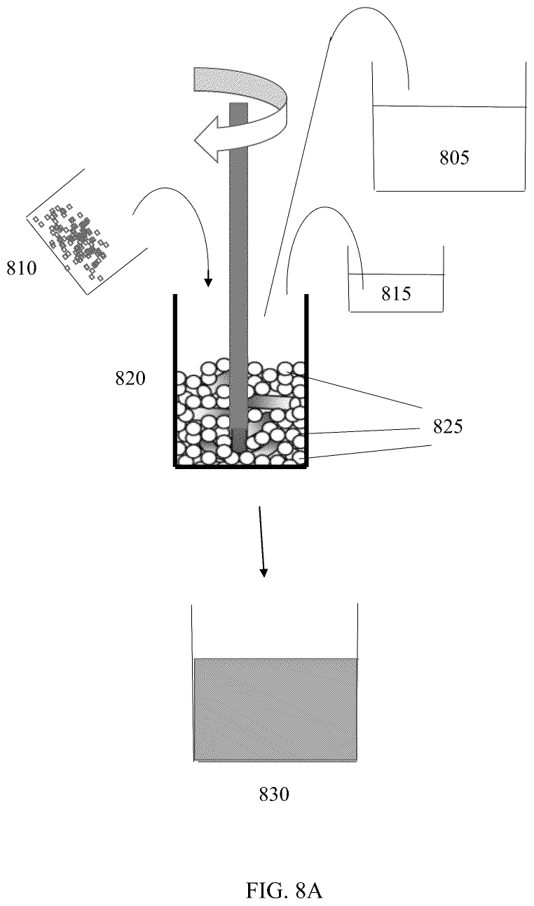

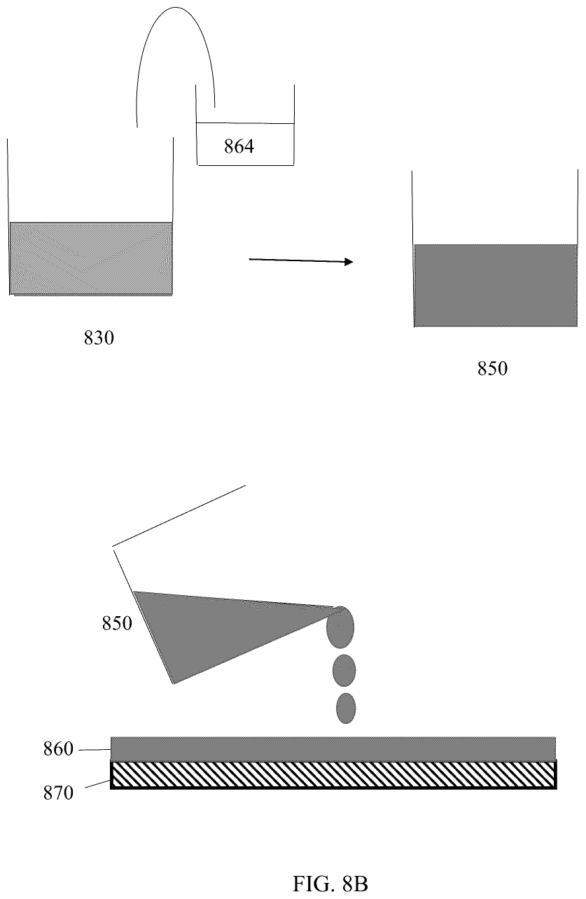

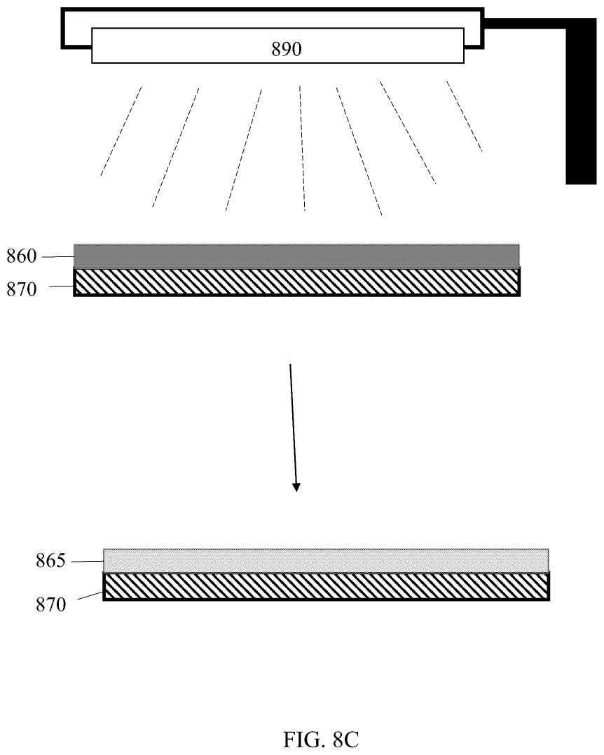

An example of the process of the preparation of the dispersion composition of the present invention is illustrated in FIGS. 8A-8C. The preparation of a predispersion is described in FIG. 8A. Into an agitated ball mill 820 comprising metal balls 825, are added a liquid carrier 805, filler particles 810 and an additive 815. The mixture is milled until predispersion 830 is produced comprising dispersed de-aggregated and stable filler particles. Into predispersion 830, polymerizable monomer or oligomer 864 is added and mixed to prepare the dispersion composition 850. Dispersion composition is coated onto a substrate 870 as an uncured film 860, which is exposed to ultraviolet radiation using UV light 890. During this step, a cured polymer film 865 is prepared.

Alternatively, polymerizable monomer or oligomer may be included in the predispersion. That is, a mixture of liquid carrier 805, filler particles 810, an additive 815, and polymerizable monomer or oligomer 864 is milled until predispersion is produced comprising dispersed de-aggregated and stable filler particles. The corresponding dispersion composition is applied onto a substrate (or inserted into a mold) and cured to produce a polymer film or a polymer part.

### EXAMPLES

### Example 1

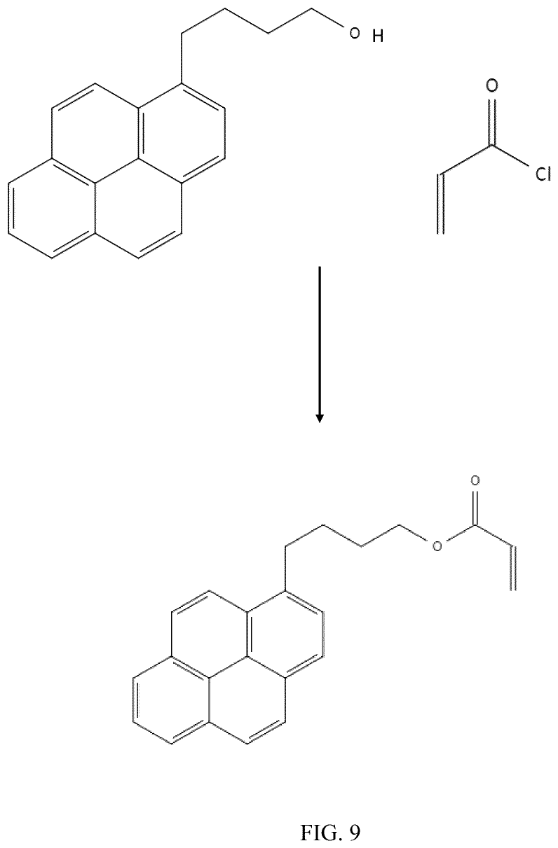

A pyrene group was attached to acrylic acid functionality via the reaction between 1-pyrenebutnol and acryloyl chloride as illustrated in FIG. 9. The product of this reaction, 4-(1-pyrenyl)butyl acrylate, can be used as is in the dispersion composition of the present invention or it can be oligomerized or polymerized before its use. Alternatively, it can be oligomerized or polymerized with other acrylic or methacrylic monomers before its use.

### Example 2

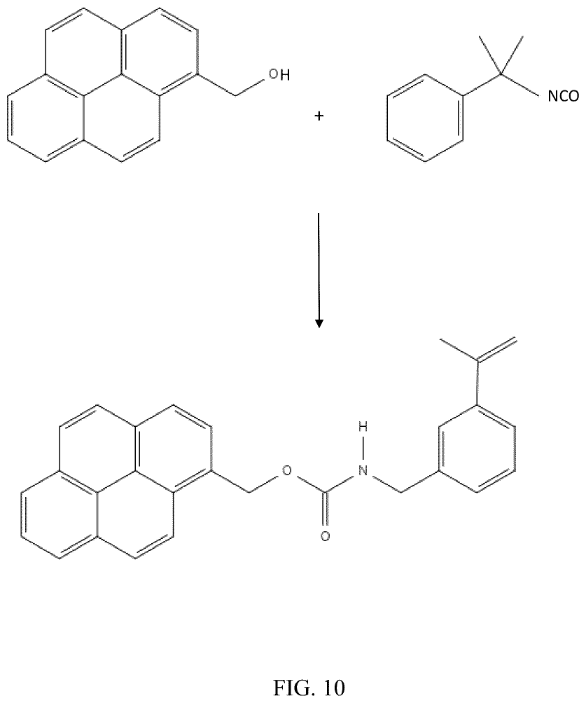

An amount of 0.6505 g (2.80 mmol) of 1-pyrenemethanol was added into a 10 mL scintillation vial, followed by the addition of 3.20 g of tetrahydrofurane. After dissolution of the solid in the solvent, an amount of 0.538 grams (2.67 mmol) of 3-isopropenyl-α,α-dimethylbenzyl isocyanate was added, followed by the addition of 0.0084 g (0.013 mmol) of dibutyltin dilaurate. The vial was purged with nitrogen and allowed to react under ambient conditions for 24 hours. Complete consumption of the isocyanate functionality was confirmed by infrared spectroscopy (absence of —N═C═O stretch at approximately 2250 cm⁻¹) yielding the desired carbamate as illustrated in the reaction scheme of FIG. 10.

### Example 3

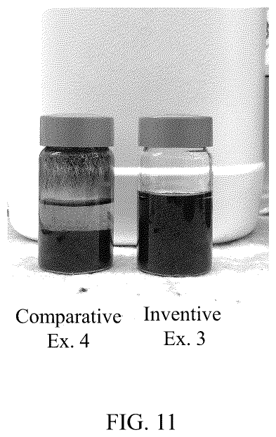

An amount of 1.1934 g of the solution prepared in Example 2 was added into a scintillation vial, followed by the addition of 0.10 g of multi-walled carbon nanotubes (supplied by Sigma; 659258) and 8 g of toluene. The mixture was sonicated for 5 minutes by a sonicator (Q Sonica Model Q700 at 50% amplitude). The prepared dispersion was stable towards settling for at least 7 days, as shown in the photograph of FIG. 11 labeled “Inventive Ex. 3”.

### Comparative Example

An amount of 0.10 g of multi-walled carbon nanotubes (supplied by Sigma; 659258) and 8 g of toluene. The mixture was sonicated for 5 minutes by a sonicator (Q Sonica Model Q700 at 50% amplitude). The prepared dispersion settled within 2 hours, as shown in the photograph of FIG. 11 labeled “Comparative Ex. 4”.

The results of the comparison between the dispersion of Examples 3 and 4 shows that the dispersion composition that comprises additive having a polycyclic aromatic group is stable towards settling. This means that the dispersion can be readily used to form a consistent polymeric film having improved performance, in terms of color or conductivity or mechanical properties, in comparison to the corresponding dispersion that does not comprise the additive.

### Example 5

The composition from Example 3 may be used to form an anisotropic adhesive layer. A polymerizable monomer or oligomer may be added into the dispersion composition, along with an initiator, if necessary. The dispersion composition that comprises the polymerizable monomer or oligomer may then be applied onto a substrate to form a wet film. An electric filed is applied across the wet film to align the filler particles at the z direction of the film. The alignment is performed by application of an electric field of 0.2 kV/cm and 1 kHz. The final step is curing of the polymer matrix via application of heat or exposure to UV radiation to form a layer having anisotropic conductivity. The conductivity of the adhesive layer is higher at the z direction of the layer (perpendicular to the plane of the layer) in comparison to the conductivity at the x and y directions (lateral conductivity).

The invention claimed is:

1. A method of making a polymer film comprising the steps:
mixing a composition comprising (a) an electrically conductive filler; (b) a polymerizable monomer or oligomer; and (c) an additive that is represented by Formula I,
R1—(CH₂)ₙ—Y—Z Formula I
wherein R1 is a polycyclic aromatic group comprising from 10 to 24 aromatic atoms, the aromatic atoms being selected from the group consisting of carbon, nitrogen, oxygen, and sulfur; n is 0, 1, 2, 3, 4, 5, 6, 7 or 8; Y is a functional group selected from the group consisting of ester, thioester, amide, urea, thiourea, carbamate, S-thiocarbamate, beta hydroxyester, -Q-CR2R3—CR4(OH)—, and -Q-SiR5R6—; Q being O, NH or S; R2, R3, R4 being independently hydrogen, or linear or branched alkyl group having 1-6 carbon atoms; R5, R6 being independently alkyl groups having 1-4 carbon atoms; and Z is a group comprising a reactive functional group, the reactive functional group being selected from the group consisting of acrylate, methacrylate, styrene, methyl styrene, epoxy, isocyanate, hydroxy, thiol, carboxylic acid, carboxylic acid halide, silane, and amine;
applying the composition onto a substrate as a wet film;
applying an electric field across the wet film to align the filler particles in the wet film at a z direction perpendicular to a plane of the applied wet film; and
curing the applied composition to polymerize the polymerizable monomer or oligomer along with the additive.

2. The method of making a polymer film of claim 1, wherein the curing is performed thermally or via exposure to ultraviolet light.

3. The method of making a polymer film of claim 1, wherein Y of the additive is —O—C(O)— or —O—C(O)—NH—, and Z of the additive comprises acrylate methacrylate, styrene, or methylstyrene.

4. The method of making a polymer film of claim 1, wherein the filer is selected from the group consisting of carbon nanotubes, carbon nanofibers, graphene, carbon black, and mixtures thereof

5. The method of making a polymer film of claim 1, wherein the composition comprises a liquid carrier selected from the group consisting of an aqueous carrier, a non-aqueous carrier, and a combination thereof.

6. The method of making a polymer film of claim 1, wherein the polycyclic aromatic group R1 of the additive comprises an aromatic system selected from the group consisting of naphthalene, acenaphthylene, acenaphthene, phenalene, fluorene, phenanthrene, anthracene, fluoroanthene, carbazole, dibenzofuran, dibenzothiophene, acridine, xanthene, thioxanthene, benzo[c]fluorene, benz[a]anthracene, pyrene, triphenylene, chrysene, tetracene, pentacene, benzo[a]pyrene, benz[e]acephenanthrylene, benzo[k]fluoranthene, benzo[j]fluoranthene, dibenzo[a,h]anthracene, perylene, coronene, corannulene, benzo[ghi]perylene, dibenzo[a,e]pyrene, dibenzo[a,h]pyrene, dibenzo[a,i]pyrene, dibenzo[a,l]pyrene, indeno[1,2,2-c,d]pyrene, and porphyrin.

7. The method of making a polymer film of claim 3, wherein the substituent of the polycyclic aromatic group R1 of the additive is selected from the group consisting of 1-(acryloyloxy)methyl, 1-(methacryloyloxy)methyl, 2-(acryloyloxy)ethyl, 2-(methacryloyloxy)ethyl, 3-(acryloyloxy)propyl, 3-(methacryloyloxy)propyl, 4-(acryloyloxy)butyl, and 4-(methacryloyloxy)butyl.

8. The method of making a polymer film of claim 1, wherein the polycyclic aromatic group R1 of the additive further comprises another substituent R8 directly bonded to an aromatic ring of the additive, the R8 being selected from the group consisting of an alkyl group, a halogen-substituted alkyl, a hydroxyalkyl, an alkenyl and a halogen, wherein the alkyl, the halogen-substituted alkyl, the hydroxyalkyl, and the alkenyl group comprises from 1 to 8 carbon atoms.

9. The method of making a polymer film of claim 1, wherein the additive is represented by Formula X or Formula XI, wherein n can be 0, 1, 2, 3, 4, 5, 6, 7, or 8.

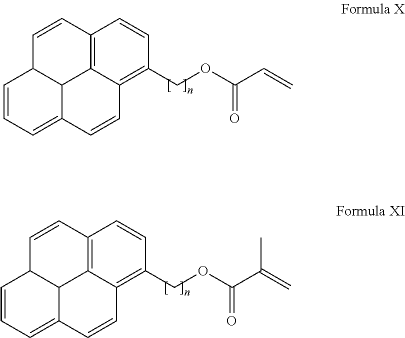

10. The method of making a polymer film of claim 1, wherein the additive is selected from the group consisting of 11-naphthalenyl 2-propenoate, 1-naphthalenyl 2-methyl 2-propenoate, 2-naphthalenyl 2-propenoate, 2-naphthalenyl 2-methyl 2-propenoate, 1-naphthylmethyl acrylate, 1-naphthylmethyl methacrylate, 2-naphthylmethyl acrylate, 2-naphthylmethyl methacrylate, 2-(1-naphthyl)ethyl acrylate, 2-(1-naphthyl)ethyl methacrylate, 2-(2-naphthyl)ethyl acrylate, 2-(2-naphthyl)ethyl methacrylate, 3-(1-naphthyl)propyl acrylate, 3-(1-naphthyl)propyl methacrylate, 3-(2-naphthyl)propyl acrylate, 3-(2-naphthyl)propyl methacrylate, 4-(1-naphthyl)butyl acrylate, 4-(1-naphthyl)butyl methacrylate, 4-(2-naphthyl)butyl acrylate, 4-(2-naphthyl)butyl methacrylate, 5-(1-naphthyl)pentyl acrylate, 5-(1-naphthyl)pentyl methacrylate, 5-(2-naphthyl)pentyl acrylate, 4-(2-naphthyl)pentyl methacrylate, include 1-anthracenyl 2-propenoate, 1-anthracenyl 2-methyl 2-propenoate, 2-anthracenyl 2-propenoate, 2-anthracenyl 2-methyl 2-propenoate, 9-anthracenyl 2-propenoate, 9-anthracenyl 2-methyl 2-propenoate, 1-anthracenylmethyl acrylate, 1-anthracenylmethyl methacrylate, 2-anthracenylmethyl acrylate, 21-anthracenylmethyl methacrylate, 9-anthracenylmethyl acrylate, 9-anthracenylmethyl methacrylate, 2-(1-anthracenyl)ethyl acrylate, 2-(1-anthracenyl)ethyl methacrylate, 2-(2-anthracenyl)ethyl acrylate, 2-(2-anthracenyl)ethyl methacrylate, 2-(9-anthracenyl)ethyl acrylate, 2-(9-anthracenyl)ethyl methacrylate, 3-(1-anthracenyl)propyl acrylate, 3-(1-anthracenyl)propyl methacrylate, 3-(2-anthracenyl)propyl acrylate, 3-(2-anthracenyl)propyl methacrylate, 3-(9-anthracenyl)propyl acrylate, 3-(9-anthracenyl)propyl methacrylate, 4-(1-anthracenyl)butyl acrylate, 4-(1-anthracenyl)butyl methacrylate, 4-(2-anthracenyl)butyl acrylate, 4-(2-anthracenyl)butyl methacrylate, 4-(9-anthracenyl)butyl 1 acrylate, 4-(9-anthracenyl)butyl methacrylate, 5-(1-anthracenyl)pentyl acrylate, 5-(1-anthracenyl) pentyl methacrylate, 5-(2-anthracenyl) pentyl acrylate, 5-(2-anthracenyl)pentyl methacrylate, 5-(9-anthracenyl) pentyl acrylate, 5-(9-anthracenyl) pentyl methacrylate, (1-Phenanthryl)methyl acrylate, (1-Phenanthryl)methyl methacrylate, (2-Phenanthryl)methyl methacrylate, (2-Phenanthryl)methyl acrylate, (3-Phenanthryl)methyl methacrylate, (3-Phenanthryl)methyl acrylate, (4-Phenanthryl)methyl methacrylate, (4-Phenanthryl)methyl acrylate, (5-Phenanthryl)methyl methacrylate, and (5-Phenanthryl)methyl acrylate.

11. The method of making a polymer film of claim 1, wherein the polymerizable monomer or oligomer is a material selected from the group consisting of acrylate, methacrylate, polyacrylate, polymethacrylate, vinyl acrylate, vinyl methacrylate, styrene, methylstyrene, epoxide, isocyanate, carboxylic acid, carboxylic acid halide, silane, alcohol, thiol, amine, and mixtures thereof.

12. The method of making a polymer film of claim 1, wherein the composition comprises a crosslinker.

13. The method of making a polymer film of claim 1, wherein the polymer film has a thickness of from 0.1 μm to 5 mm.

14. The method of making a polymer film of claim 1, wherein the content of the electrically conductive filler is from 0.01 weight percent to 15 weight percent by weight of the composition.

15. The method of making a polymer film of claim 1, wherein the electrically conductive filler is carbon black, the carbon black having specific surface area that is higher than 120 m²/g measured via BET.

16. The method of making a polymer film of claim 1, wherein the electrically conductive filler is single-wall carbon nanotubes or multi-wall carbon nanotubes, which are cylindrical particles with diameter of less than 100 nm.

17. The method of making a polymer film of claim 1, wherein the electrically conductive filler is carbon nanofibers with diameter of from 5 μm to 10 μm.

18. The method of making a polymer film of claim 1, wherein the electrically conductive filler is graphene having specific surface area of from 300 m²/g to 2600 m²/g.

19. The method of making a polymer film of claim 1, wherein the polymer film is a conductive film, a barrier film, an electrode, a sealing layer, an edge seal or an adhesive layer.

20. The method of making a polymer film of claim 1, wherein the polymer film is an adhesive layer of an electro-optic device, the electro-optic device comprising a first electrode layer, an electro-optic material layer, the adhesive layer; and a second electrode layer comprising a plurality of pixel electrodes, wherein the electro-optic material layer is disposed between the first and second electrode layer, and wherein the electro-optic material layer comprises an encapsulated electrophoretic medium.
